(19) United States
(12) Patent Application Publication
(10) Pub. No.: US 2006/0108198 A1
(43) Pub. Date: May 25, 2006

(54) Device for forming groups of products, for instance for automatic packaging machinery

(75) Inventor: Dario Guidetti, Prato Sesia (Novara) (IT)

Correspondence Address: PATTERSON & SHERIDAN, L.L.P., 3040 POST OAK BOULEVARD, SUITE 1500, HOUSTON, TX, 77056, US

(73) Assignee: Cavanna S.p.A.

(21) Appl. No.: 11/274,379

(22) Filed: Nov. 14, 2005

(30) Foreign Application Priority Data
Nov. 25, 2004 (EP) 04425887.9

(51) Int. Cl. B65G 47/26

(52) U.S. Cl. 198/431

(57) ABSTRACT

A device for forming groups of products comprising: a stationary base structure, a support, movable relative to the base structure, and a plurality of grip units borne by the movable support, the grip units being movable from a position for receiving products, to a position for releasing the groups of products, and being capable of receiving the products advancing along a given direction in the position of receipt and of forming groups of products comprising a predetermined number of products. The grip units can be selectively disassembled and re-assembled relative to the movable support independently from each other.

### CROSS-REFERENCE TO RELATED APPLICATIONS

The present application is based on, and claims priority from, European Application Serial Number 04425887.9, filed Nov. 25, 2004, the disclosure of which is hereby incorporated by reference herein in its entirety.

### FIELD OF THE INVENTION

The present invention relates to a device for forming groups of products, for instance for automatic packaging machinery.

### BACKGROUND OF THE INVENTION

Product conveying systems of automatic packaging installations are often provided with devices able to subdivide the products that advance along a continuous array into groups of products which are fed to a packaging station.

### SUMMARY OF THE INVENTION

The present invention was developed paying particular attention to the need to provide a device able to receive in a given position products which advance, e.g. in a substantially continuous array, to form groups, each comprising a predetermined number of products and to deposit the groups in position of release. For example, the device for forming groups of products can be positioned between a first conveyor that advances the products along a continuous array and a second conveyor that receives from the device in question successive groups of products to be fed to a packaging station.

Each group can be formed by single products, not packaged individually, or by previously packaged products which are gathered in groups to form multiple packages of individually packaged products.

To fix ideas, without thereby limiting the scope of the invention, the products in question can be, for example, food products, e.g. confectionery products or dairy products.

In some sectors of the food industry, there are specific needs that bear heavily on the design of packaging machines. For example, for some applications in which the treated products are prone to release particles, fragments or crumbs, there is the need to be able rapidly to disassemble and reassemble the main components of the packaging machine in order thoroughly to clean the machine. This is, for example, the case of packaging machines for the dairy industry, where the machine must be cleaned frequently so that it is necessary for the assembly and disassembly of devices used to move the products to be executed rapidly and in simple fashion.

Substantially similar considerations also apply in relation to the need (which often emerges in automatic packaging installations) to vary the number of products comprising each group, e.g. to adapt the machine to different product packaging configurations.

The requirement outlined above, however, may clash with the fact that the machine is intended to operate in environments with controlled atmosphere. This means that the operations to assemble and disassemble the components of the machine are usually performed by the same personnel that supervises the normal operation of the machines, without the intervention of maintenance personnel outside the production departments. To avoid disturbing the atmosphere of the production departments, it is also necessary for disassembly and re-assembly operations to be capable of being executed by hand and without using tools, equipment, etc.

Moreover, in many countries there are safety and worker protection regulations which establish, for instance, specific limits for the weights to be lifted/moved during manually operated disassembly and re-assembly operations.

The object of the present invention is to provide a conveyor device to form product groups which allows to meet all the aforesaid requirements.

According to the present invention, said object is achieved by a device having the characteristics set out in the claims. The claims are an integral part of the technical teaching provided herein in relation to the invention.

### BRIEF DESCRIPTION OF THE DRAWINGS

The device according to the present invention shall now be described in detail with reference to the accompanying drawings, provided purely by way of non limiting example, in which:

FIG. 1 is a schematic lateral view illustrating the operation of the device according to the present invention,

FIG. 2 is a schematic perspective view of the part indicated by the arrow 11 of FIG. 1,

FIG. 3 is perspective view in enlarged scale of the part indicated by the arrow III in FIG. 1,

FIGS. 4 and 5 are perspective views from different angles of a grip unit of the device according to the invention.

### DETAILED DESCRIPTION OF THE DRAWINGS

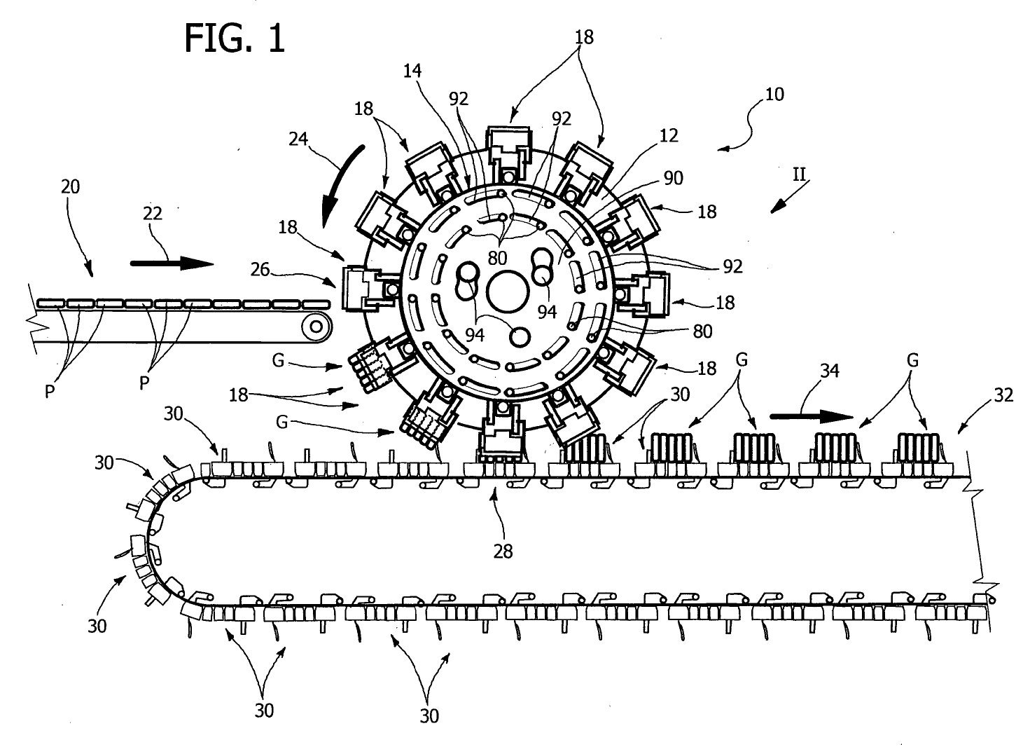

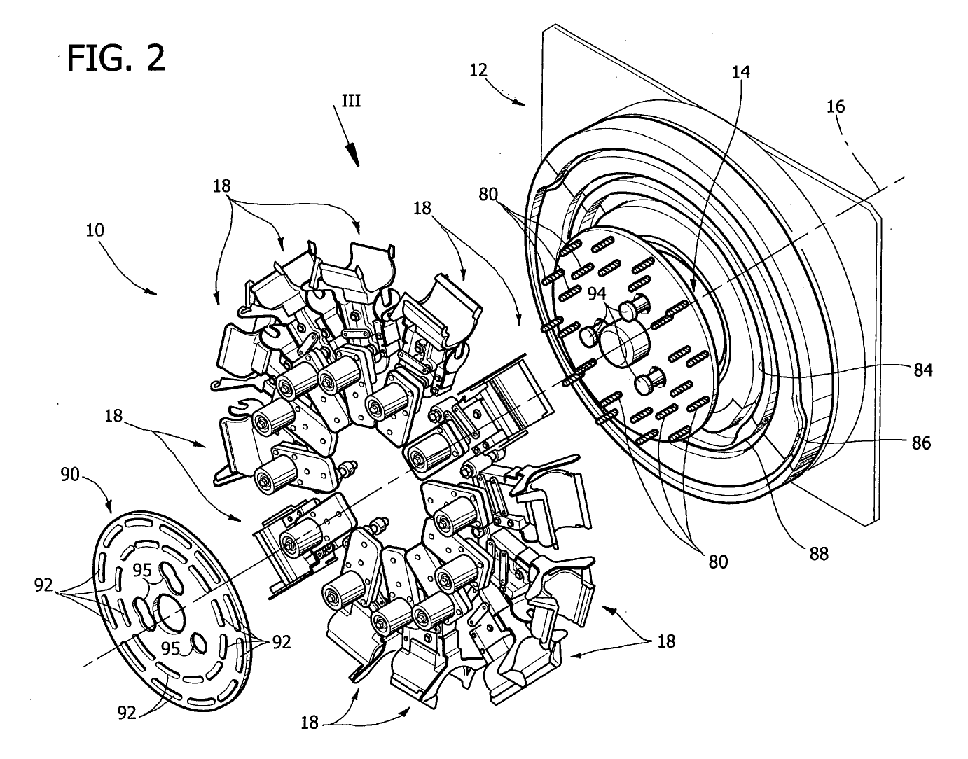

With reference to FIGS. 1 and 2, the reference number 10 designates a conveyor device according to the present invention for forming groups of product. The device 10 comprises a stationary base structure 12 (FIG. 2) which bears a support 14, movable with respect to the base structure 12. In the example illustrated in the figures, the support 14 is substantially disc shaped and it is rotatable relative to the stationary structure 12 around an axis of rotation 16 coinciding with the main axis of symmetry of the support 14. In a practical embodiment of the invention, the axis of rotation 16 extends horizontally.

The movable support 14 may have a different shape from the one illustrated and it may be provided with a different movement from the circular movement. For example, the disc shaped support 14 could be replaced by a flexible conveyor member such as a belt or a chain closed in a loop along a path of movement with a generic shape.

The device 10 comprises a plurality of grip units 18 borne by the movable support 14. The grip units 18 are arranged uniformly along the perimeter of the movable support 14.

With reference to FIG. 1, a first conveyor 20 feeds one or more substantially continuous arrays of products P along a direction indicated by the arrow 22. By effect of the rotation of the movable support 14 in the direction indicated by the arrow 24, the grip units 18 move in succession to a position of reception of the products P indicated by the arrow 26. In this position, each of the grip units 18 receives a predetermined number of products P forming a group G. The grip units 18 deposit the respective group of products G in a position of release 28. In the illustrated example, the grip units 18 deposit the respective groups of products G on respective conveyance units 30 of a second conveyor 32, movable in the direction indicated by the arrow 34 in FIG. 1. The second conveyor 32 can, for example be as described in a simultaneous European Patent application by the same Applicant, with the title: “Conveyor device, for instance for an automatic packaging machine and relative transport element”.

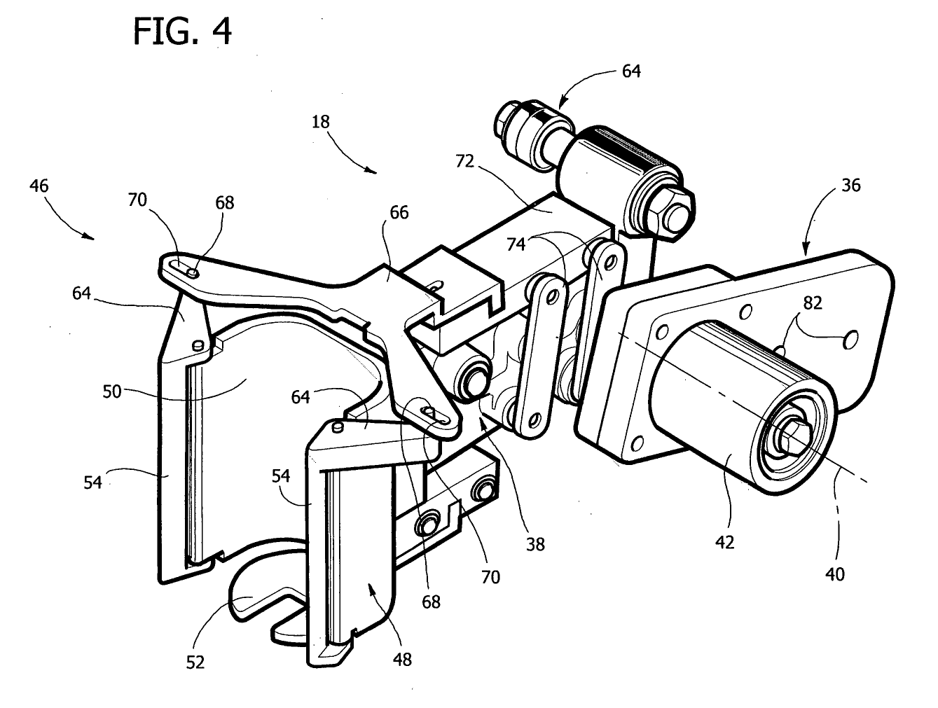

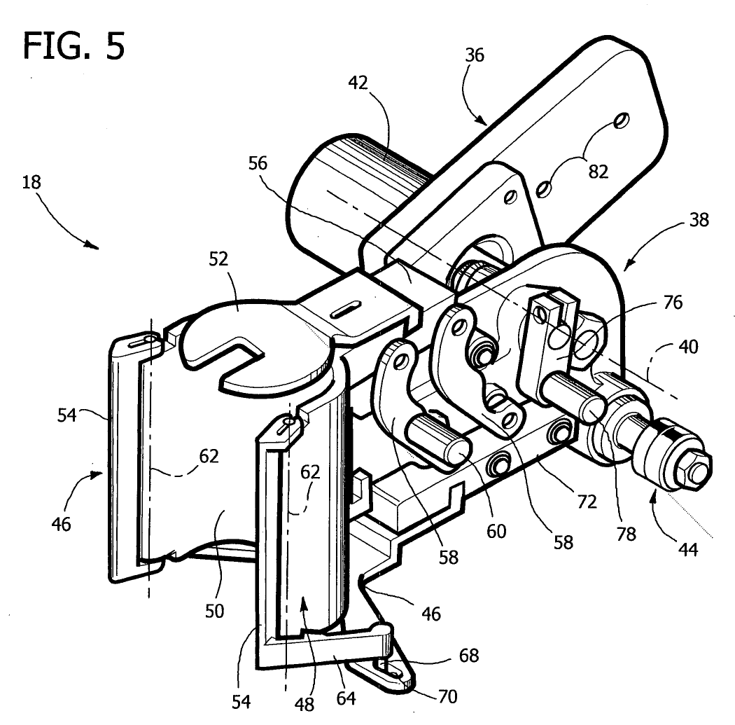

With reference to FIGS. 4 and 5, each grip unit 18 comprises a fastening base 36 preferably constituted by an element of substantially flattened parallelepiped shape made of metallic material. Each grip unit 18 comprises an oscillating body 38 rotatably mounted relative to the fastening base 36 around an axis 40. The fastening base 36 has a cylindrical extension 42 within which is housed a bearing (not shown) which bears, rotatably around the axis 40, a pivot pin fastened to the oscillating body 38. The oscillating body 38 bears a first pin formation 44 which extends parallel and at a certain distance relative to the axis of rotation 40.

The oscillating element 38 bears a pincer 46 able to receive and to retain a group of products G. The pincer 46 comprises a containment member 48 with substantially channel-like shape having an inner surface 48 with shape and dimensions corresponding to those of the group of products G.

The pincer 46 is able to assume a product reception configuration, a stop configuration and a product release configuration. The pincer 46 is provided with a movable support element 52 and with two oscillating closure elements 54. The support element 52 is movable along a direction that is substantially orthogonal to the axis of rotation 40 between a position of support of the group of products and a release position. The support element 52 is fastened to a first carriage 56 connected to the oscillating body 38 by means of a first pair of levers 58 positioned according to an articulated quadrilateral configuration. One of the lever 58 is provided with a second pin formation 60 parallel to the axis of rotation 40.

The closure elements 54 of the pincer 46 are articulated around respective edges of the containment member 48 along mutually parallel axes 62, orthogonal relative to the axis of rotation 40. The closure elements 54 are provided with respective arms 64 connected to a fork element 66 by means of respective pivot pin and slit connections 68, 70. The fork element 66 is fastened to a second carriage 72 movable relative to the oscillating element 38 along a substantially orthogonal direction relative to the axis of rotation 40. The second carriage 42 is connected to the oscillating body 38 by means of a second pair of levers 74 arranged according to an articulated quadrilateral configuration.

One of the levers 74 is fastened to an actuating member 76 provided with a third pivot pin formation 78 parallel to the axis of rotation 40. With reference to FIG. 5, the pivot pin formations 44, 60 and 78 are all parallel to each other and positioned on the same side of the oscillating element 38. These three pivot pin formations constitute respective cam-following organs actuating, respectively, the oscillatory motion of the body 38 relative to the fastening base 36 around the axis 40, the sliding motion of the support element of the products 52 and the opening/closing motion of the closure elements 54.

With reference to FIG. 2, the grip units 18 can be selectively disassembled and assembled on the movable support 14 independently from each other. The movable support 14 and the grip units 18 are provided with mutually co-operating engagement formations. Preferably, the engagement formations are so arranged as to allow the assembly and the disassembly of each grip unit 18 with a movement along a direction parallel to the axis 16 of the movable support 14 and to the axis of rotation 40 of each grip unit 18.

In the embodiment illustrated in the drawings, the engagement formations for connecting the grip units 18 to the movable support 14 comprise a pivot pin and hole connection. A plurality of pins 80 are fastened to the movable support 14 in predetermined positions. The pins 80 are oriented parallel to the axis of rotation 16 and they project from the movable support 14 from the opposite side relative to the stationary base structure 12.

With reference in particular to FIGS. 4 and 5, the fastening base 36 of each grip unit 18 is provided with two holes 82 with axes that are parallel to each other and to the axis of rotation 40, able to be coupled in engagement relationship with a pair of pivot pins 80 of the movable support 14. The disassembly and assembly of each grip unit 18 relative to the movable support 14 is obtained with the simple movement of the grip unit, as a result of which a pair of pins 80 is coupled or uncoupled relative to the pair of holes 82 of the fastening base 36.

With reference to FIG. 2, the device 10 comprises three cam formations, fixed relative to the stationary base structure 12, designated by the references 84, 86 and 88. These three cam formations are preferably formed by grooves which extend along respective closed paths, external with respect to the movable support 14. The cam formations 84, 86 and 88 receive in sliding guide relationship the pivot pin formations 44, 60, 78 of the grip units 18. During the engagement of each grip unit 18 on the movable support 14, the pivot pin formations 44, 66, 78 are inserted in the respective grooves constituting the cam formations 84, 86, 88. To facilitate the insertion of the pin formations in the respective cam formations, the pins 80 preferably have a length exceeding the thickness of the fastening base 36. It is thereby possible to insert the holes 82 on the ends of the pivot pins 80 and to position the pivot pins 44, 60, 78 in alignment with the respective cam formations 84, 86, 88 and, lastly, to complete the engagement by fully thrusting the fastening base 36 until it comes in contact with the movable support 14. To disassemble the grip units 18, it is sufficient to extract the grip units with a movement in a direction that is parallel to the axes of the pivot pins 80.

It can be noted that the assembly and disassembly of the grip units 18 can be performed manually and without using tools or equipment.

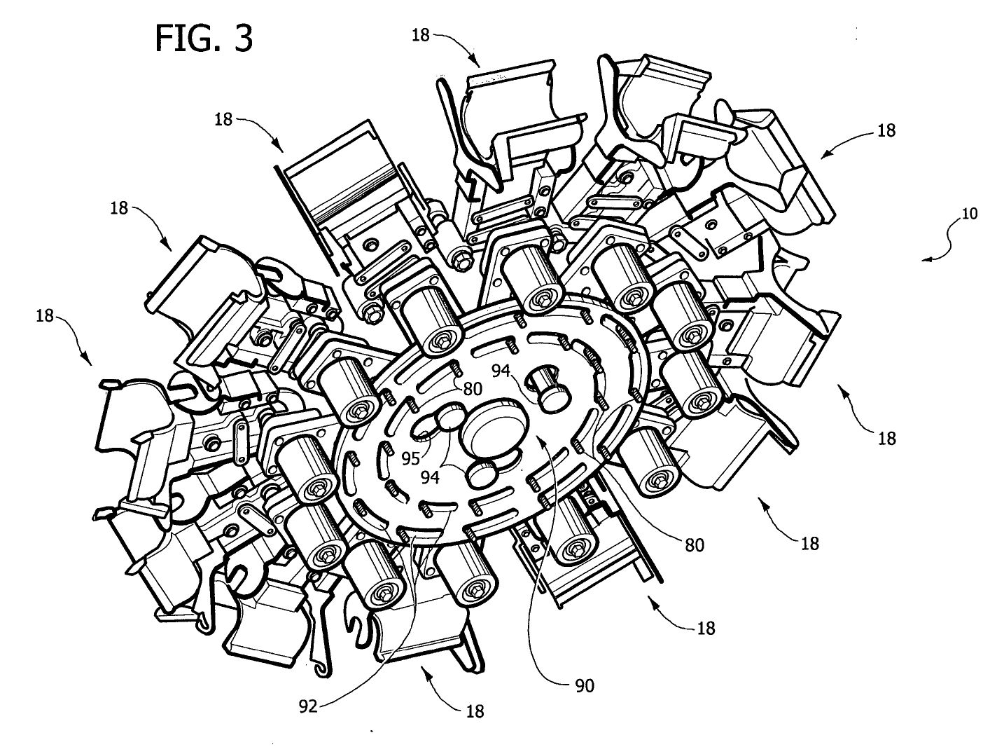

With reference to FIGS. 2 and 3, the device 10 comprises a fastening plate 90 which allows to fasten in stable fashion the fastening bases 36 of all the grip units 18 to the movable support 14, preventing undesired movements of the grip units 18 in the direction of removal during operation. The fastening plate 90 is provided with slots 92 through which extend the ends of the pivot pins 80 projecting beyond the fastening bases 36 of the grip units 18. The fastening plate 90 is also provided with holes 95 through which extend fastening elements 94 having a widened head, borne by the movable support 14 and movable in parallel direction to the axis of rotation 16 between a position of fastening and a position of disengagement of the plate 90. In the position of fastening illustrated in FIG. 3, the plate 90 bears against the fastening bases 36 of all grip units 18 and it is fastened to the rotating support 14 by means of the fastening elements 94.

With reference to FIG. 1, in operation the movable support 14 rotates with constant speed around the axis of rotation 16. The shape of the cams 84, 86 and 88 is defined in such a way that when a grip unit 18 is in the position of receipt of the products 26, the pincer 46 of the grip unit is in the condition of receipt of the products. In this condition, the support element 52 is positioned in such a way as to form a bearing surface for the products and the closure elements 54 are in open position. The products P are made to advance in the direction 22 of the conveyor 20 and are loaded in the pincer 46 of the grip unit 18 which is in the position of receipt of the products.

At the position of receipt of the products 26, the cam 84 commands an oscillation of the oscillating body 38 around the axis of rotation in opposite direction from the direction of rotation 24 of the movable support 14. In this way, the pincer 46 which is in the position of receipt of the products 26 slows the movement of advance in the direction 24. In this way, the pincer 46 advances more slowly than the support 14 until the products forming a group are loaded on top of each other in the pincer 46.

Once the loading of a group G of products is complete, the closure elements 54 close in such a way as to hold the group of products G in the pincer 46. Once the loading of a group of products is complete, the oscillating element 38 of the grip unit 18 oscillates around the axis 40 in the same direction as the axis of rotation of the movable support 14 to return to the initial position. When the grip unit 18 reaches the position of release of the products 28, the cams 84 and 88 bear the pincer 46 in the configuration of release of the products in which the support element 52 is withdrawn with respect to the oscillating body 38 and the closure elements 54 are in open position. The group of products G is thus deposited on a transport element 30 of the conveyor 32.

In order to clean thoroughly the device 10, the grip units are disassembled from the support 14. To perform said assembly operation, it is sufficient to remove the plate 90 after having commanded the extraction (e.g. by means of pneumatic actuators) of the fastening elements 94. Then, the individual grip units 18 are removed independently from each other. The weight of the individual grip units 18 is sufficiently low to enable to perform the disassembly operation manually and without using lifting devices.

The disassembly of the grip units 18 can also be necessary if the device 10 needs to be adapted to groups of products with different format. In this case, the grip units 18 are replaced by other grip units with pincers adapted to the new product format. In case of replacement of the grip units for the format change, it may be necessary to modify the cams 84, 86, 88 which actuate the motion of the movable parts of the grip units. For this purpose, the cam formations 84, 86, 88 can be formed on sectors selectively removable from the stationary base structure 12, which can be replaced by other sectors with different shape of the cams 84, 86, 88.

It will be appreciated, in any case, that the operations described previously imply the lifting and the actuation of the individual grip units 18. Even when the device 10 globally has considerable dimensions—and hence weight—each of the units 18 has reduced weight, and therefore can be handled without effort.

The device according to the present invention may be subject to numerous variants from what is described and illustrated herein. For example, each grip unit 18 may be provided with two or more pincers 46. The shape of said pincers may also vary as a function of the shape of the products and of the way in which said products are mutually approached to form a group of products.

1. A device for forming groups of products, comprising:
a stationary base structure,
a support, movable relative to the base structure, and
a plurality of grip units borne by said support in such a way as to be movable from a position for receiving the products, where said grip units are capable of receiving said products advancing along a given direction, to a position for releasing the products, where said grip units are capable of releasing said products ordered in groups comprising a predetermined number of products,
wherein said grip units can be selectively disassembled and assembled relative to the movable support independently from each other.

2. Device as claimed in claim 1, wherein the grip units and the support are provided with mutually co-operating engagement formations capable of mutually coupling or uncoupling as a result of a relative motion along a rectilinear direction.

3. Device as claimed in claim 2, wherein said engagement formations comprise pivot pin formations co-operating with holes having corresponding shape.

4. Device as claimed in claim 1, wherein each grip unit comprises at least one pincer for retaining a respective group of products.

5. Device as claimed in claim 1, wherein said at least one pincer comprises movable elements able to move between a position for receiving and releasing the products and a position for retaining the products.

6. Device as claimed in claim 5, comprising cam formations that are fixed relative to the stationary base structure and co-operating with cam-following members borne by said grip units and able to actuate the displacement of said movable elements of said pincer.

7. Device as claimed in claim 2, wherein said grip units comprise respective fastening bases, provided with engagement formations, said grip units further comprising respective oscillating bodies mounted rotatably relative to the fastening bases.

8. Device as claimed in claim 7, comprising a cam formation that is fixed relative to the stationary base structure and co-operating with cam-following members borne by said oscillating bodies of the grip units, said cam formation being able to actuate an oscillatory movement of the oscillating bodies relative to the respective fastening bases.

9. Device as claimed in claim 7, comprising a fastening plate able to be selectively fastened and removed relative to the movable support and positioned in such a way as to fasten the fastening bases of the grip units to the movable support.
